(19) United States
(12) Patent Application Publication
(10) Pub. No.: US 2009/0256460 A1
(43) Pub. Date: Oct. 15, 2009

(54) METHOD FOR PREVENTING OR REDUCING HELIUM LEAKAGE THROUGH METAL HALIDE LAMP ENVELOPES

(75) Inventors: Gary Robert Allen, Chesterland, OH (US); Rajasingh Schwartz Israel, Westlake, OH (US); Elizabeth Anne Guzowski, Cleverland Heights, OH (US); Rocco Thomas Giordano, Garfield Heights, OH (US); Peter W. Brown, Twinsburg, OH (US); Deeder Aurongzeb, Mayfield Heights, OH (US)

Correspondence Address: Fay Sharpe LLP, 1228 Euclid Avenue, 5th Floor, The Halle Building, Cleveland, OH, 44115, US

(73) Assignee: General Electric Company

(21) Appl. No.: 12/102,578

(22) Filed: Apr. 14, 2008

(51) Int. Cl. H01J 7/24; H01J 61/16; H01J 9/02

(52) U.S. Cl. 313/33; 313/643; 445/27

(57) ABSTRACT

A lamp and method for the reduction of gas loss in a high temperature lamp includes providing a light source and a surrounding shroud, using a fill gas outside of the light source and inside the shroud having a thermal conductance greater than nitrogen, and modifying the shroud so that it contains at least 20% of the initial fill gas for at least the rated life of lamp operation. The shroud is preferably modified by one or more of selecting the shroud material, controlling the thickness of the shroud, providing a coating on the shroud, and the selection of the fill gas.

### BACKGROUND

The present disclosure relates to high-temperature lamps characterized by having optical or photometric performance, or life, or reliability that is limited by the high temperature of the light source, or the high temperature of the envelope that encloses the light source. It finds application with regard to high temperature discharge lamps with and without electrodes, incandescent and halogen lamps, LED lamps, and other high temperature lamps. It finds particular application with regard to metal halide lamps with ceramic or quartz arctube envelopes, and the use therein of helium, hydrogen, neon, or other low-mass gas as a fill gas in place of nitrogen or vacuum between the arc tube and the surrounding lamp shroud or outer jacket. The present disclosure finds particular application with regard to metal halide lamps in applications for automotive headlamps, narrow spot lamps, or compact lamps. However, it is to be appreciated that the present disclosure will have wide application throughout the lighting industry.

A current, commercially available headlamp design is based on use of a quartz shroud hermetically attached to, and surrounding, a quartz metal halide arctube. A next generation headlamp design might use a ceramic metal halide arctube and also incorporate a quartz shroud with a fill of either N₂ or vacuum between the headlamp arc tube and shroud. The usual advantages enabled by the replacement of quartz with ceramic are expected to accrue in a ceramic discharge headlamp, possibly including higher LPW, better color, Hg-free dose, and improved maintenance of lumens and color over life of the lamp, among others. Due to the scattering of light by a typical ceramic arctube envelope, however, the dimensions of the ceramic arctube must be made significantly smaller than the dimensions of a quartz arctube in the same application in order to provide the high brightness, compact light source with low scattered light levels required to produce a high performance beam. Typically, the outer diameter of the ceramic arctube must be made comparable to the inner diameter of the quartz to achieve comparable optical performance. The ceramic arc tube temperatures that are obtained in operation of such a small ceramic arc tube in such a design are typically at or above maximum acceptable temperatures for the ceramic material. Typically an arctube operating in a vacuum environment will run hotter than the same arctube operating in a gas-filled (typically N₂) environment, although even in an N₂ atmosphere, the temperature of such a small ceramic arctube is typically excessively high. In other words, the dimensions of the ceramic arc tube cannot be made small enough without incurring negative effects from the higher temperatures in the application of a ceramic arctube for a discharge headlamp. A similar situation is typically found in other lamp applications where the favorable performance attributes of a ceramic metal halide arctube are preferable to those of the quartz metal halide arctube which is typically used in the application, but in order to provide a high-brightness beam in spite of the scattering by the ceramic arctube, the dimensions of the ceramic must be made so small that the ceramic operates too hot. A similar situation is also typically found in any application where a high-brightness light source is desired to be mounted inside a smaller outer jacket or a smaller lamp reflector than that of the existing product so that the lamp can be mounted into a smaller reflector or a smaller enclosure, but the more compact geometry results in an operating temperature of the ceramic arctube envelope which is unacceptably high. When the arctube envelope is too hot, the adverse results can include short lamp life, low reliability, poor maintenance of lumens or color over life, and risk of rupture of the arctube, among others.

One way to reduce the temperature of a quartz or ceramic arctube envelope is to use a gas filling in the space between the arctube and the outer jacket, or shroud, that conducts heat better than the current typical fill gas, which is usually nitrogen or a mixture of nitrogen and other gases, or a vacuum. The use of a fill gas having substantially higher thermal conductivity than nitrogen results in cooler arctube temperatures. This cooling capability allows the size of the arc tube, and thereby the entire lamp assembly to be smaller, therefore resulting in a more optically favorable light source. In the case of a ceramic arc tube, the smaller dimensions can further provide a more isothermal envelope temperature that significantly reduces stresses and thereby reduces the probability of failure due to cracking.

Several gases, including helium and hydrogen have been proposed for use as the fill gas to reduce arc tube temperatures, therefore allowing for a smaller arctube design (see, for example, US20070057610A1 which discloses a gas-filled shroud to provide a cooler arctube). A smaller arctube design will improve optical performance of the headlamp or the beam-forming lamp or the compact lamp, and also serve to reduce stresses that will result in longer lamp life.

The problem to be solved by this disclosure is the difficulty encountered in containing an alternate fill gas that has a higher thermal conductivity, such as helium or hydrogen, in a quartz shroud or outer jacket surrounding the arctube so that the cooling benefit of the alternate fill gas enables successful operation of the arctube with smaller dimensions than a conventional arctube. The proposed gases all have thermal conductivity that exceeds that of N₂ gas, and the atoms or molecules of such gases are typically smaller than N₂ molecules, and typically have higher permeation rates through quartz or glass than does N₂ gas. In particular, helium and hydrogen permeate through quartz very rapidly, and the permeation rate increases with increasing temperature of the quartz. The thermal and stress benefits of helium or hydrogen cooling gas are lost after the majority of the gas has permeated outwardly and been lost through the shroud to the outside. After the cooling gas is lost, the arctube will still operate at very high brightness due to its small dimensions, but it will operate much hotter than intended and will suffer the adverse results from overheating. For helium contained inside a quartz envelope, this occurs after approximately 100 hours of operation, while for hydrogen this occurs between approximately 250 and 500 hours of operation at typical operating temperatures of high-temperature lamps with the typical quartz shroud used with a metal halide lamp. This is to be contrasted with the design lifetime of a typical discharge headlamp of approximately 2,000-5,000 hours, and that of a general lighting discharge lamp, typically on the order of 10,000 hours or more. Clearly, a containing design is desired for keeping the helium or hydrogen within the shroud while the lamp is operating for thousands of hours.

Given the foregoing, while the use of helium, hydrogen, or another fill gas having a higher thermal conductivity than nitrogen, may solve certain problems surrounding the use of nitrogen, such use nonetheless requires modifications of the shroud in order to eliminate or satisfactorily lessen permeation through the quartz.

Yet another drawback to headlamp performance is that one of the functions of nitrogen gas inside the headlamp shroud is to inhibit electrical breakdown through the gas across the outside electrical leads of the arc tube. This occurs when a high voltage ignition pulse, for example son the order of 25 kV, is applied from the lamp ballast or power source. Due to the very high ionization potential of helium, helium gas may be sufficient to inhibit the breakdown, but it may require an addition of a small amount of N₂ or other gas to further inhibit breakdown.

### SUMMARY OF THE DISCLOSURE

The disclosure relates to a lamp having helium, hydrogen, or a similar fill gas having a thermal conductance greater than that of nitrogen disposed between the arctube and the lamp shroud, wherein at least 20% of the original hydrogen, helium, or similar fill gas content is retained by the shroud over the rated lifetime of the lamp.

The invention further relates to a method of eliminating or reducing helium or hydrogen (or similar fill gas) permeation through a shroud or outer jacket.

A preferred method and lamp includes providing a lamp arctube and a surrounding shroud, using a fill gas outside of the arctube and inside the shroud having a thermal conductance greater than nitrogen, and modifying the shroud so that it contains at least 20% of the initial fill gas for at least the rated life of the lamp.

The shroud-modifying step and resulting lamp includes at least one of selecting a shroud substrate, coating on the shroud, shroud wall thickness, and choice of gas for containment purposes.

The method and lamp includes using a fill gas having a thermal conductance greater than nitrogen, such as one of helium, hydrogen, or neon as the fill gas (or an amount of nitrogen gas could be added thereto), and wherein the coating includes one of alumina, silica, tantala, titania, niobia, hafnia, and NiO, or other light-transmitting high-temperature material oxides, nitrides or oxynitrides or combinations thereof.

The method and resultant lamp includes forming the shroud of an aluminosilicate glass (Corning type 1720 or GE type 180 aluminosilicate) or other high-temperature glass having at least 5% molar fraction of alkali oxides and alkaline earth oxides in the glass.

The method and resultant lamp includes applying a high temperature coating to one or both of an inner and outer surface of the shroud.

A primary benefit is cooler arctube temperatures. and the corresponding ability to design the arctube and lamp assembly to be smaller.

Another benefit results from possible reduction in the stresses and the corresponding reduction in probability of failure due to cracking.

Yet another benefit is to maintain cooler arctube temperatures for a lamp assembly that operates for thousands of hours.

Still other benefits and advantages will become apparent from reading and understanding the following detailed description.

### BRIEF DESCRIPTION OF THE DRAWINGS

FIG. 1 illustrates a double-ended lamp design.

FIG. 2 illustrates a single-ended lamp design.

FIG. 3 is a graph illustrating use of helium and nitrogen at various spacings between the external leads of the arctube.

FIG. 4 is a table listing several candidate glasses including their softening points and molar content of alkali plus alkaline earth oxides.

FIG. 5 is a graph illustrating helium containment in vessels comprised of various substrates at 550° C.

FIG. 6 is a graph illustrating helium containment in a quartz vessel with various coatings at 550° C.

FIG. 7 is a graph illustrating helium containment in quartz, GE 180 aluminosilicate glass, and soda-lime glass vessels at 550° C.

FIG. 8 is a graph showing predicted and experimental effect of the wall thickness of the vessel on helium containment.

FIG. 9 is a graph illustrating containment of hydrogen in a doped quartz vessel.

FIG. 10 is a graph showing containment of hydrogen in an aluminosilicate glass vessel.

FIG. 11 is a table showing the measured percentage of cooling gas retained in various test vessels after 200 hours in a furnace at about 550 C.

FIG. 12 is a table showing the expected percentage of cooling gas retained in a test vessel after 2000 hours in a furnace at about 550 C.

FIG. 13 is a table showing the estimated percentages of cooling gas retained in a test vessel after 10,000 hours in a furnace at about 550 C.

### DETAILED DESCRIPTION

A high temperature discharge arc tube such as a ceramic metal halide (CMH) lamp, and in particular a CMH lamp for use as a headlamp, is provided that contains helium, hydrogen, or other cooling gas in a small, high-temperature, light-transmitting shroud where the cooling gas results in a reduction of the hot spot temperature and the capability to design a smaller, more optically favorable arctube. For purposes of reference, and as noted above, high-temperature lamps are characterized by having optical or photometric performance, or life, or reliability that is limited by the high temperature of the light source, or the high temperature of the envelope that encloses the light source. High temperature lamps include, for example, discharge lamps with and without electrodes, incandescent and halogen lamps, LED lamps, and other high temperature lamps.

In order to contain a cooling gas such as helium or hydrogen within the shroud, one or more of three arrangements can be used. The first concept involves a minimum wall thickness of the shroud. The second concept involves replacing a conventional quartz shroud with a high-temperature glass shroud, for example aluminosilicate glass. A third concept involves applying a high-temperature coating to the surface of the shroud. For example, a combination of all three features would be characterized by a 1-2 mm thick shroud made of an aluminosilicate glass coated with a high temperature thin film. The aluminosilicate glass has a high softening temperature of 1015° C., and a high anneal temperature of 785° C., therefore qualifying the glass as suitable for most high-temperature lamp applications, and in particular for the CMH headlamp application. The aluminosilicate shroud can be coated on its inside and/or outside surface with a material that further impedes the diffusion loss of helium or hydrogen from the envelope, such as a 50 nm to 10 μm thick layer, and more preferably approximately 1-3 μm thick layer, of alumina, silica, tantala, titania, niobia, hafnia, zirconia, NiO, or other light-transmitting high-temperature material oxides, nitrides or oxynitrides or combinations thereof, with decomposition point greater than 500 C, or a multi-layer interference coating of tantala-silica, titania-silica, or other combination of high-temperature, high and low index materials, for the anti-reflection benefit.

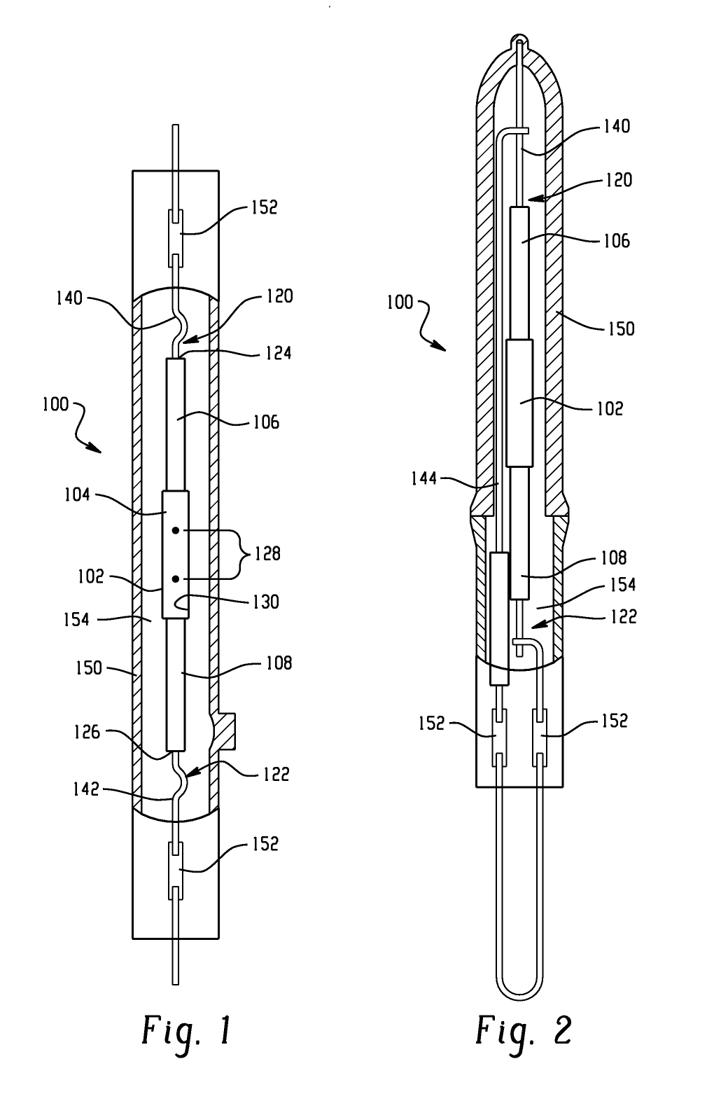

The lamp 100 includes a body or vessel also referred to as an envelope or arctube 102 having a cavity or discharge chamber 104 with first and second legs 106, 108 extending axially outward therefrom. The legs receive electrode/lead wire assemblies 120, 122, respectively, that are connected to an external power source (not shown). In addition, seals 124, 126 are provided at each outer end of the legs to hermetically seal the electrode assemblies relative to the legs. For example, a preferred seal is a frit seal that is typically provided along a portion of the lead wire assembly. An inner end of each electrode/lead wire assembly extends into the discharge chamber and is spaced apart by a predetermined distance from the corresponding inner end on the opposite side of the arc chamber that is defined as an arc gap or arc length indicated by reference numeral 128. An internal or bore diameter 130 of the arc chamber is also referenced in FIG. 1.

Axial outer portions or outer lead portions 140, 142 of double-ended lamp of FIG. 1 are electrically and mechanically associated with the first and second electrode/lead wire assemblies 120, 122, respectively. In the single-ended lamp of FIG. 2, a support 144 extends in generally parallel, offset relation to the arctube and supports the outer lead portion 140. The lamp 100 is preferably received in an outer jacket, capsule, or shroud 150. In all references to the word “shroud” in this disclosure, it is meant any enclosure surrounding the light emitter of the lamp that provides for a controlled gas environment in the volume surrounding the light emitter. In some descriptions of lamps in the literature the word “shroud” may be replaced by “outer jacket” or “outer bulb” or “lamp envelope” or “housing” or similar description.

The arctube geometry represented in FIGS. 1 and 2 may be referred to as a double-ended arctube design, while the configuration of the lamp, or the outer jacket, or the shroud is referred to as double-ended in FIG. 1 and single-ended in FIG. 2. However, this disclosure applies equally well to a single-ended arctube design wherein both electrode/lead wire assemblies 120, 122 are positioned adjacent to each other. Such a single-ended arctube geometry is typically mounted inside a single-ended lamp geometry like that of FIG. 2. Furthermore, this disclosure also applies equally well to an electrodeless discharge lamp.

According to the present disclosure, the arctube is made of polycrystalline alumina or PCA. The use of PCA allows the lamp to run at higher temperatures than a quartz lamp without suffering devitrification or other adverse reactions of the arctube envelope material. The shroud is generally made from quartz, and in selected embodiments of the present disclosure the shroud is formed from a high-temperature glass shroud, for example aluminosilicate glass (Corning type 1720 or GE type 180 aluminosilicate), or other high-temperature glass having at least 5% molar fraction of alkali oxides and alkaline earth oxides in the glass.

In addition to the foregoing, standard electrode materials are used such as niobium wire, molybdenum wire, and tungsten wire. Alternatives to these electrode materials are cermet (ceramic metal) materials that are known for use as electrodes.

The arctube of the CMH lamp further includes a standard fill gas component, such as argon, krypton, or xenon, that is sealed in the arctube upon construction, and metal and metal halide components, such as the iodides, bromides, or chlorides of Ca, Ce, Ti, Na, Nd, Dy, Ho, Tm, La, Sc, Li, Cs, Mg, Sr, Ba, Al, Sn, In, Ga, or other known dosing materials, and also Hg or Zn or ZnI₂ or other dose material intended to provide a high electrical impedance to the discharge arc. The envelope material of the arctube may be polycrystalline alumina (PCA), microcrystalline alumina (MCA), single-crystal alumina (sapphire), yttrium-aluminum garnet (YAG), aluminum oxynitride (AION), yttralox, magnesium-aluminum oxide (spinel) or other high-temperature, light-transmitting ceramic.

The shroud is sealed about the arctube, i.e., sealed at each end with a molybdenum foil 152 received in sealed ends (FIG. 1) or a sealed end (FIG. 2). The space or cavity 154 between the arctube and the shroud 150 is typically filled with nitrogen gas, and in accordance with the teachings of the present disclosure with helium (the present disclosure will refer to helium, although it will be appreciated that other fill gases such as hydrogen, neon, or still other cooling gases having substantially higher thermal conductivity than nitrogen could be used) at a pressure of about 1 atmosphere, or else a vacuum, in the void between the headlamp shroud and the ceramic discharge arc tube of the headlamp. At least about 20% of the original helium fill pressure of about 1 atmosphere is preferably maintained for about 3,000 hours. under operating temperatures of the shroud or outer jacket reaching about 500° C. Several methods are disclosed herein that achieve the foregoing minimization of helium loss even at higher operating temperatures.

The use of helium gas to replace the conventional nitrogen fill gas existing in the void between the headlamp arctube and the shroud provides advantages with respect to several parameters of headlamp operation. In one embodiment, the replacement of nitrogen with helium allows the arctube envelope to run at a cooler temperature. In another embodiment, the use of helium results in the arctube envelope running at cooler temperatures, which provides the capability to design the headlamp assembly in a much smaller format resulting in a more optically favorable light source. The use of helium, however, has its own attendant problems. For example, helium tends to permeate through a quartz shroud quickly, especially at higher temperatures. This permeation of the helium gas eventually leads to a loss of the thermal and stress benefits initially gained by the use of helium, as the helium fill diffuses through the shroud, which occurs after about 100 hours of operation.

The use of helium as a fill gas without the loss of thermal and stress benefits is accomplished herein by modifying shroud 150, thus prohibiting or satisfactorily reducing the permeation of helium. In one embodiment, modification is made to the headlamp design by replacement of the quartz shroud with a shroud of aluminosilicate glass. One consideration in the use of glass as a shroud material revolves around the temperature limitations thereof. Aluminosilicate glasses have a softening point of about 1,015° C., and an anneal point of about 785° C. These temperatures exceed the expected shroud hot spot temperature of approximately 500-700° C. Therefore, an aluminosilicate glass is a viable option for reducing helium permeation over extended time periods, up to about 3,000 hours.

The amount of cooling gas that should be contained at the end of the lamp life can be estimated as follows. The cooling gas is most effective at removing heat from the arctube when it operates in the fluid regime via either thermal conduction or convection, rather than in the lower-pressure molecular regime. The thermal conductivity of the gaseous medium is independent of the pressure of the gas as long as the gas medium is in the continuum regime, or fluid regime, rather than the molecular regime. The transition from the free molecular regime to the continuum regime occurs as the Knudsen number is reduced to less than about 0.1. The Knudsen number (Kn) is a dimensionless fluid parameter equal to the mean free path for collisions in the gas divided by the typical spatial dimension in the gas envelope, in this case the gap between the outside of the arctube and the inside of the shroud. For Kn less than 0.01 for helium or hydrogen cooling gas in a shroud with a 1.0 mm gap spacing between the outside of the arc tube and the inside of the shroud, the cooling gas pressure rust be greater than 200 Torr. So, if about 1 atmosphere (1 bar, 760 Torr) is initially dosed into the shroud during lamp manufacture, then it is sufficient to retain as little as 30% of the initial cooling gas amount through the life of the lamp. The required retention of cooling gas throughout the life of the lamp can be much less than 30% with some moderate degradation in the cooling effect of the gas, and/or if the gap between the shroud and the arctube is greater than 1.0 mm. If there is considerable loss of cooling gas throughout the life of the lamp, and if some percentage of N₂ has been added for the benefit of high-voltage breakdown insulation, then the amount of cooling gas which must be retained over the life of the lamp should be greater than about the initial percentage of N₂ (usually about 5-20%) in order to retain a significant contribution from the cooling gas to the cooling effect on the arctube. An estimate of the required containment of cooling gas at the rated end of life of the lamp may be taken to be ˜20% of the initial fill pressure of the cooling gas for many lamp applications or about 120 Torr remaining from an initial fill of about 600 Torr.

As previously noted, one of the functions of the nitrogen gas inside the shroud is to inhibit electrical breakdown through the gas across the outside electrical leads of the arctube when the high-voltage (˜25 kV) ignition pulse is applied from the ballast. This is a concern when the lamp design is single ended (FIG. 2) rather than double ended (FIG. 1), and both leads exit the lamp at the same side. Due to the very high ionization potential of helium, it was considered that the helium gas may or may not be sufficient to inhibit the breakdown. If the helium gas did not provide sufficient electrical insulation, then an amount of nitrogen gas could be added to the helium gas at a partial pressure of nitrogen which is low enough to avoid diminishing the thermal benefit of the helium (less than about 1 of the helium pressure), yet high enough that the electronegative benefit of the nitrogen gas is realized.

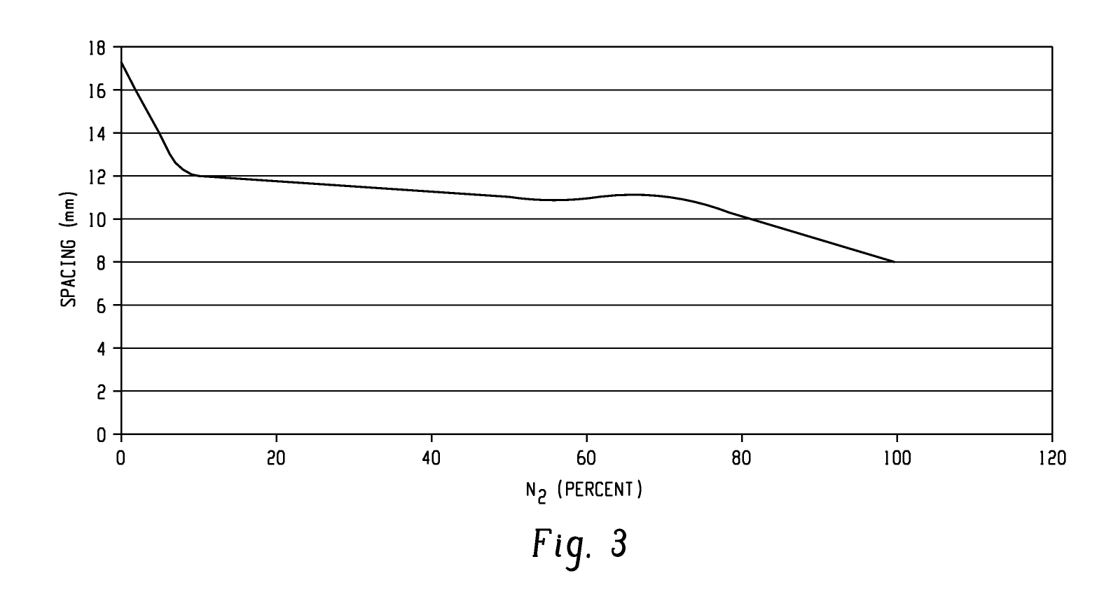

This concept was studied, and the results are shown in FIG. 3. Pure helium and pure nitrogen were both studied at various gap widths, and combinations of the two gases were studied as well. The check marks represent points where breakdown did not occur, while the “x” marks represent points where breakdown did occur. The line represents the threshold between the two. In summary, the nitrogen did indeed perform better than the helium, but combinations of the two gases could be used to inhibit breakdown at realistic gap widths. The breakdown gap observed for helium in its pure state was quite different than that of nitrogen, 17 mm compared to 8mm. However, adding only a small amount of nitrogen (about 10% at about 500 Torr total fill pressure) reduced the gap to 12 mm, where a plateau was reached. In other words, further additions of nitrogen did not greatly affect the breakdown gap width.

In another embodiment, modification is made to the headlamp design by using a thin film oxide coating to reduce helium permeation. For example. a coating of titania, tantala, niobia, or alumina, or other suitable coating, having a thickness of between approximately 1μ and 3μ, may be coated on the inside and/or the outside of the shroud 150 to minimize helium permeation. The coating may be applied as a multi-layer coating or as a single layer coating, and may be applied by any known coating technique, including chemical vapor deposition or sputtering. Of course, a single layer coating may also be applied by simpler methods, including dipping or spraying.

As has been stated, either a single layer coating of alumina, titania, tantala, or other suitable coating at approximately 1-3μ thickness, or a multi-layer coating incorporating, for example, titania or tantala or other suitable material in alternating layers with silica may be used. In the latter, the alternating layers serve as both a diffusion barrier against the permeation of cooling helium gas and as an anti-reflection coating to improve the optical beam-forming performance of the lamp. The aluminosilicate shroud 150 which bears the above coating should preferably be at least about 1 mm thick, and more preferably on the order of 2 mm thick, as a greater thickness further inhibits helium permeation. The coatings may be deposited, as stated above, on the inside, the outside, or both surfaces of the shroud.

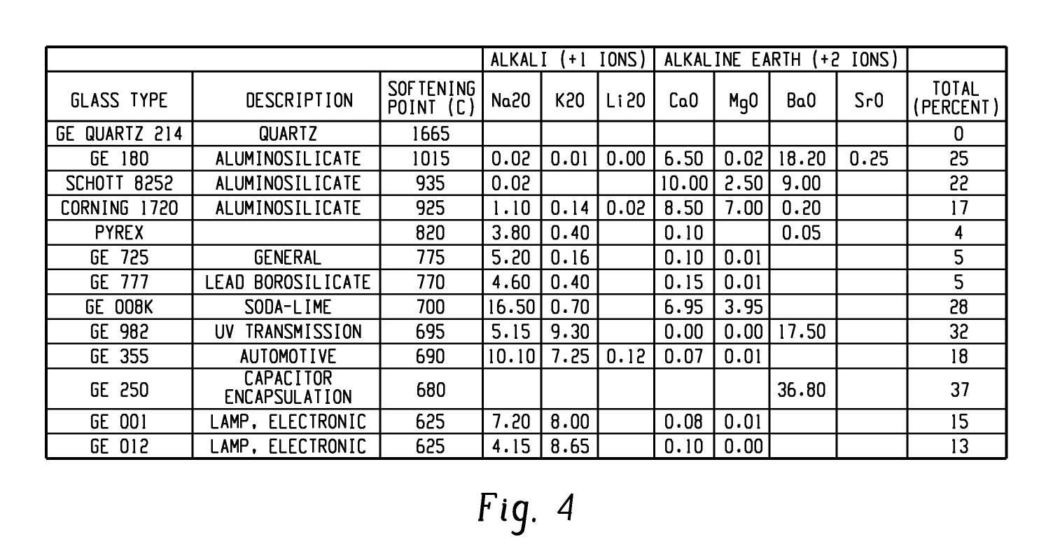

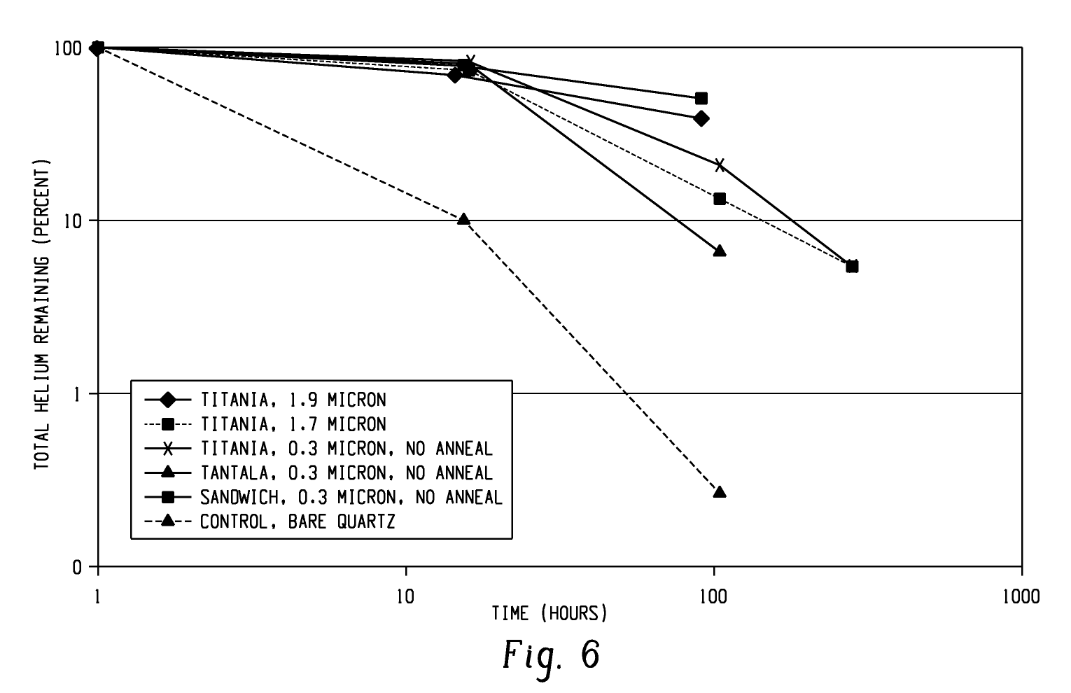

Tests have been performed to quantify helium and hydrogen containment in quartz.. It is known (see page 251 in “Introduction to Material Science, A. G. Guy, McGraw-Hill, 1972) that the permeabilities of He in soda-lime, or borosilicate (BSC), or Pyrex glasses at room temperature are about 4, 2, and 1 orders of magnitude, respectively, lower than for quartz. But they have softening points (700, 770, 820 C, respectively) and maximum working temperatures (450, 500, 550 C, respectively) that are too low for the shroud material in most high-temperature lamp applications. So, instead of testing soda-lime, BSC, or Pyrex glasses, the helium and hydrogen containment capabilities of aluminosilicate glass (softening point ˜1000 C; maximum working temperature equal to 650 C) were tested, and also various high-temperature, visibly-transmitting thin film coatings on quartz. One skilled in the art of lamp design will appreciate that some lower-temperature lamp applications could benefit from the use of soda-lime BSC, Pyrex, or other similar low-temperature glasses, and that high-temperature lamp applications can benefit from either aluminosilicate or other similar high temperature glasses, since the permeability to He and H2 of glasses, in general, is orders of magnitude lower than that of quartz. The reason for the testing on aluminosilicate glass in the present development is due to the successful use of aluminosilicate glass in commercially available high-temperature lamps, but the benefits of this disclosure pertain to other glasses, and are not limited to aluminosilicate glass only. The physical explanation of the low permeability of He in glasses, relative to that in quartz, can be found as early as 1938 in the Journal of Chemical Physics, vol. 6, pp. 612-619, and more recently and with more a more thorough listing of glasses, in V. O. Altemose, Journal of Applied Physics, vol. 32, #7, e.g. page 1314 therein. For each addition of approximately 8% of alkali and alkaline earth oxides in the glass composition, the permeation rate of He through the glass at 300 C is reduced by approximately 10 times (reference V. O. Altemose, Journal of Applied Physics, vol. 32, #7, page 1314, FIG. 6). The magnitude of reduction of penneation rate is similarly large even at higher temperatures up to the softening point of the glass. Although there are too many commercially available glasses to list all of the candidate glasses that would provide good containment of He in the outer jacket of a high-temperature lamp, FIG. 4 provides a list of representative glasses. Those containing higher molar % of alkali plus alkaline earth atoms in combination with higher softening temperatures, are most suitable. Since the softening temperature is the temperature at which the glass deforms under its own weight, the maximum useful temperature as a lamp component will be much lower. As seen in FIG. 4, the aluminosilicate glasses shown all have softening temperatures greater than 925 C, and also mole % of alkali plus alkaline earth oxides equal to 17-25%. Soda-lime glass, although it has a high mole % of alkali plus alkaline earth oxides equal to 28%, its softening temperature (about 700 C) makes it useful as a He containing glass only in cooler, lower-temperature lamp designs. It should be obvious that other glasses with a combination of high temperature capability and high molar content of alkali plus alkaline earth oxides will also provide good containment of He and other cooling gases in high-temperature lamp applications.

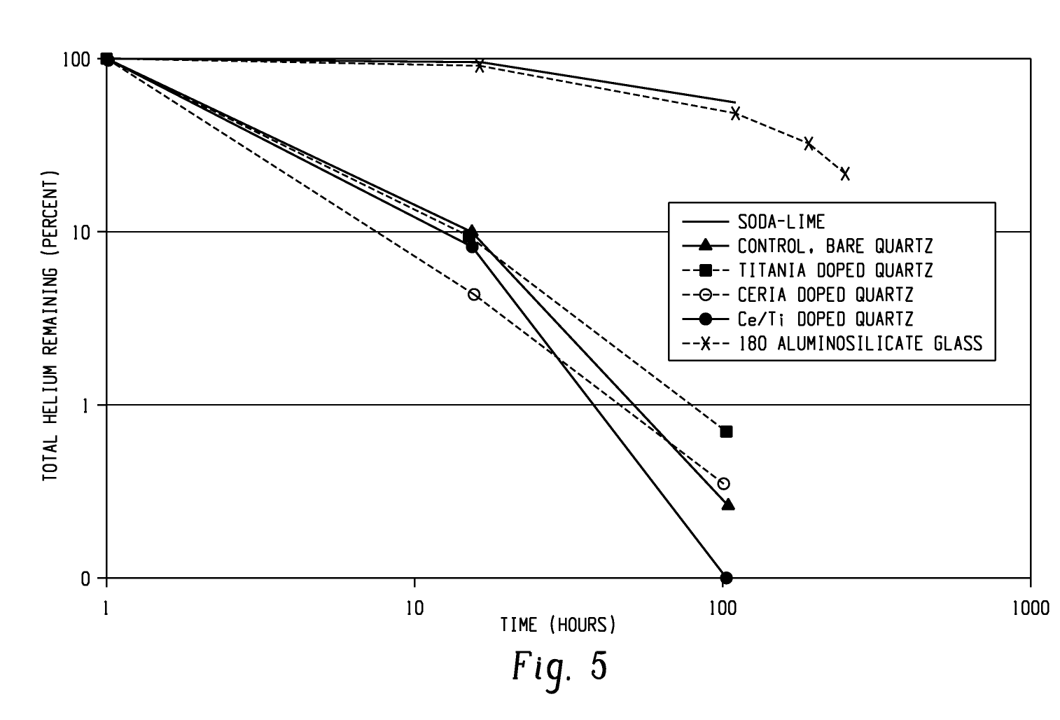

Tests have further been performed to quantify the helium and hydrogen containment capabilities of various thin film coatings. The tests were performed for extended times at 550° C., which is approximately the temperature of the outside surface of a typical shroud during lamp operation. The testing was performed by first filling numerous tubes of a known volume to a known pressure (˜600Torr) of the gas to be tested. The filled tubes were then placed in a sealed furnace at 550° C. for intervals of time. After each interval, about three tubes were taken out of the furnace and their gas pressures were measured by mass spectrometry analysis. These pressure values were then averaged, and when compared to the original pressure (0 hour mass spec reading), they represented the percentage containment capability of the substrate at that particular time. FIGS. 5 and 6 display results for helium in aluminosilicate glass compared to quartz, and for various thin film coatings on quartz. The target containment in each case is at least 20% of the initial gas pressure at 3000 hours.

FIG. 5 shows that the performance of aluminosilicate GE type 180 aluminosilicate glass is superior to that of quartz. Containment data is available for helium in quartz with coatings, but not in aluminosilicate glass with coatings, so an analytic estimate of the benefit of coating the aluminosilicate glass shroud was generated. This generated equation provides an estimate of the combined benefit of GE type 180 aluminosilicate glass and a thin film coating. The combined benefit was determined by quantifying the benefit of the 0.3 micron titania coating itself, using the results of a coated quartz tube compared to those of a bare quartz tube. The following equations show the relationship between the various parameters.

x_{G+F}^{t}=x_{G}^{t}+(1−x_{G}^{t})*(x_{F}^{t})

x_{Q+F}^{t}=x_{Q}^{t}+(1−x_{Q}^{t})*(x_{F}^{t})

In these equations, each x represents a percentage of helium contained by a given substrate, therefore meaning that 1-x represents the percentage of helium that has escaped from a given substrate. The superscript t represents time, meaning that the equation was used to solve for a combined benefit response at numerous individual times of interest. The subscripts represent the substrate or coating being considered, where
G=glass
F=film
Q=quartz

Therefore, x_{F} was determined first, using the data found for the containment of helium in a quartz shroud coated with a thin film, and that for an uncoated (bare) quartz shroud. The determination of x_{F} then made it possible to estimate x^{G+F}, the expected combined benefit of GE type 180 aluminosilicate glass and the 0.3 micron titania film.

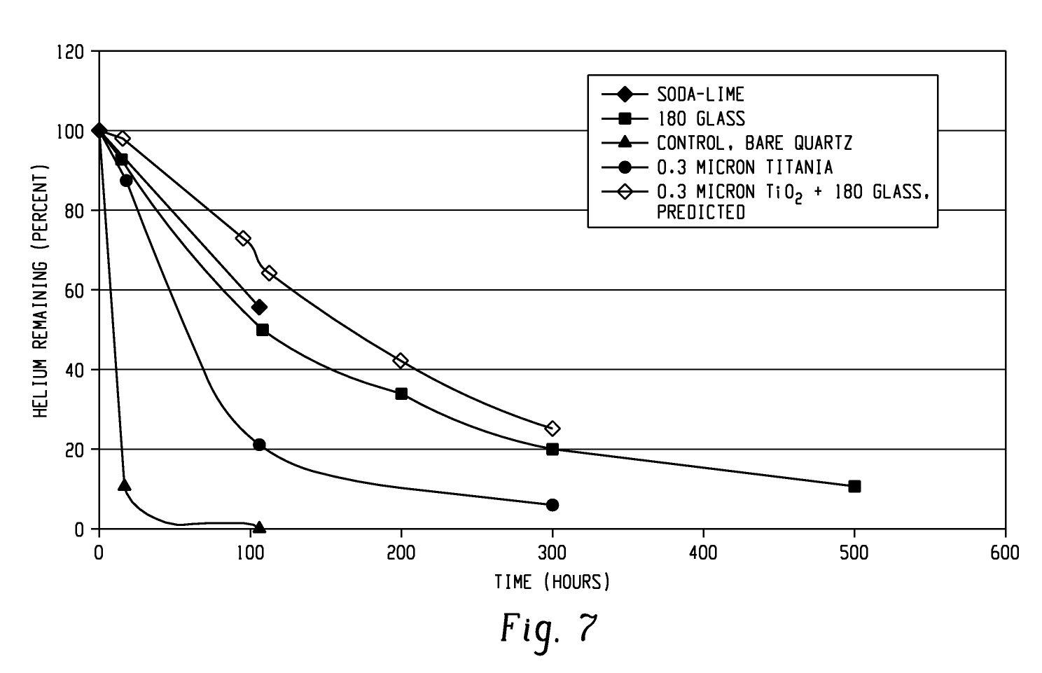

FIG. 7 shows a curve for the estimated helium containment capability of aluminosilicate GE type 180 glass coated with a 0.3 micron titania thin film.

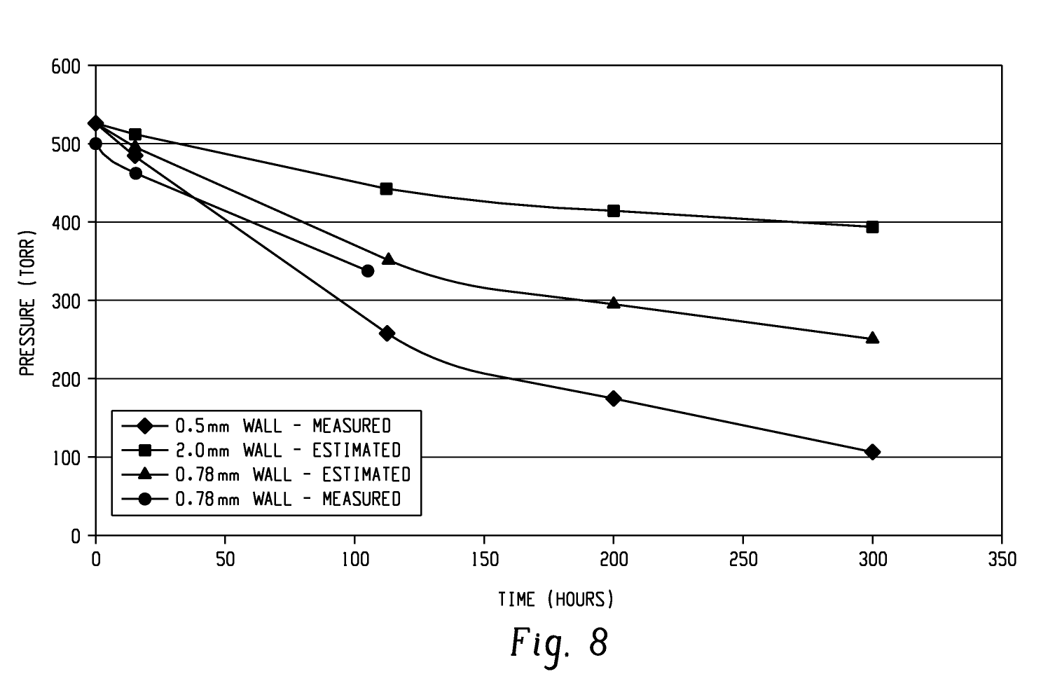

Another method of increasing the containment of helium or hydrogen within a shroud is to increase the coating or substrate thickness. In order to understand the effect of coating or substrate thickness on containment capabilities, a flux correlation was used. This correlation was used to predict how much better a thicker aluminosilicate glass would contain a fill gas, and similarly, how much better a thicker oxide coating would contain the fill gas. Thicker aluminosilicate glasses were then studied to determine the accuracy of the prediction. FIG. 8 shows that the theoretically predicted containment is quite similar to the observed containment of the thicker glass. These theoretical predictions were then used to predict containment for various combinations of substrate thickness, substrate type, coating, and cooling gas.

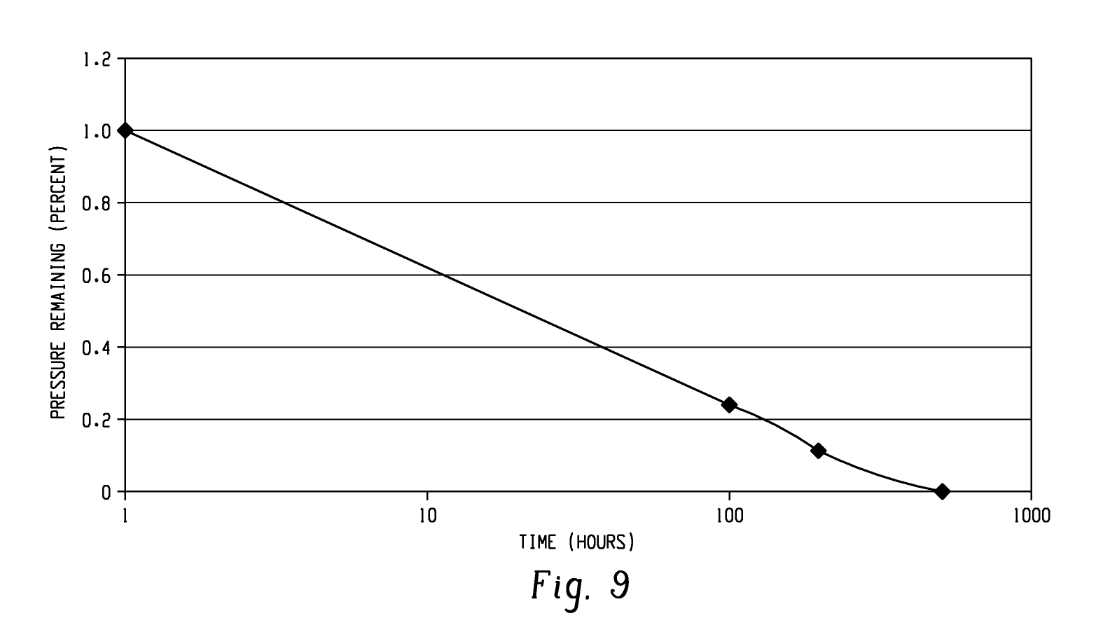

Hydrogen has also been tested for containment in various substrates at 550° C. FIG. 9 shows the containment of hydrogen in quartz tubes with 3 mm inside diameter and 5 mm outside diameter. It is clear from this study that quartz contains hydrogen more effectively than it contains helium (as shown in FIG. 5).

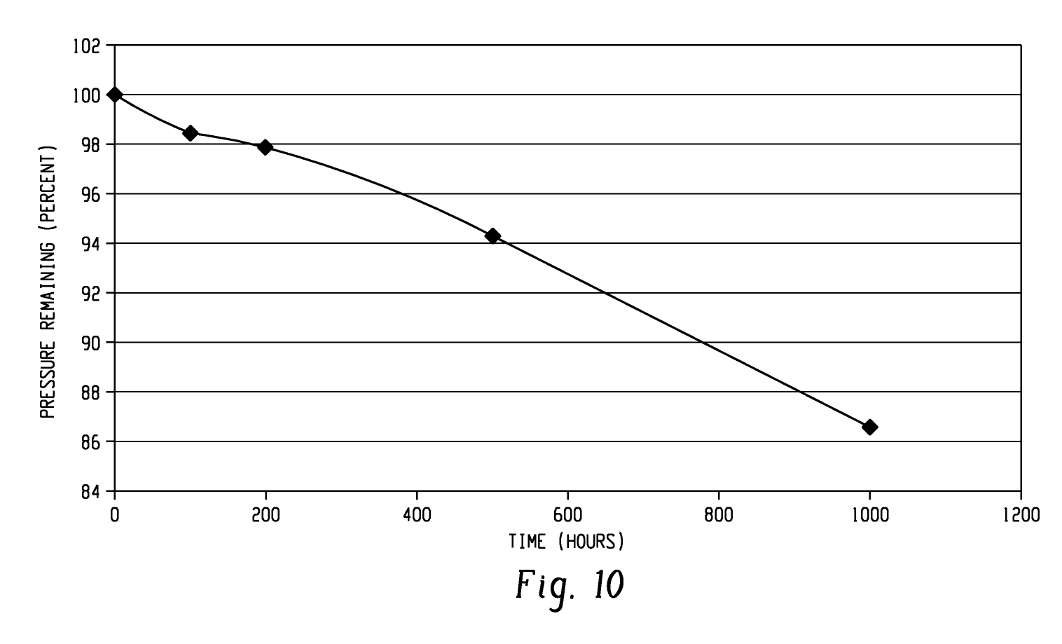

The comparison between the containment of the two gasses, hydrogen and helium, led to a quantification of how much less hydrogen diffuses than helium in a given substrate. This relationship was used to predict that aluminosilicate glass would contain a much higher percentage of hydrogen than helium. The experimental results proved this prediction true, and even exceeded the predicted percentage containment. FIG. 10 shows that aluminosilicate glass is a strong candidate for use in this application when paired with hydrogen. Hydrogen is 86% contained at 1000 hours (420 Torr remaining), which is on target for meeting the desired containment of 150 Torr at 3000 hours.

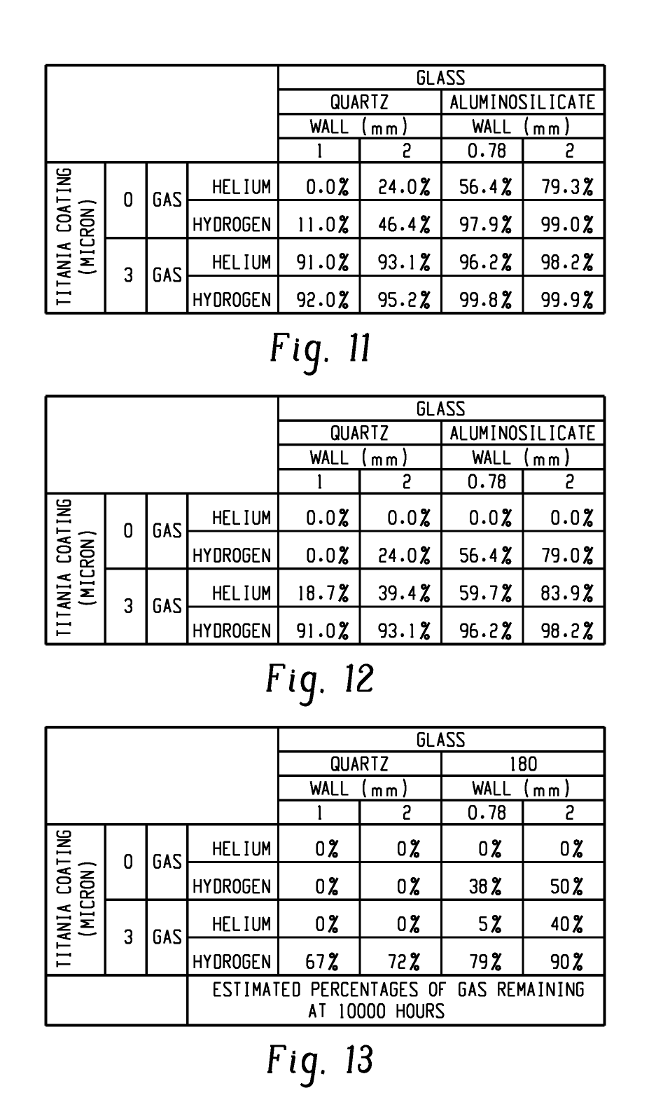

The recognition of this likely solution led to the determination of other likely solutions, based on combining the benefits of substrate, coating, thicknesses, and gas choice. The identification of some likely candidates of interest is shown in FIGS. 11, 12, and 13. These figures show that substrate and coating choice. in addition to substrate and coating thickness, all influence the gas containment capability of the shroud or outer jacket. Various solutions show promise for containing enough gas at 3000 hours, FIG. 11 shows the predicted containment of various shroud cells at 200 hours. while FIGS. 12 and 13 shows the same at 2000 and 10,000 hours. These percentage containment estimates are based on experimental data, thickness correlation calculations, and correlations between helium and hydrogen retention.

FIGS. 11, 12, and 13 show that several possible designs exist that will likely result in sufficient containment of hydrogen or helium gas at 2000, or even 10,000 hours. Preferred embodiments for a 2000 hour design include: quartz (1 mm or 2 mm) with hydrogen and 3 micron titania coating; GE type 180 aluminosilicate glass (0.78 or 2 mm) with hydrogen and no coating; and GE type 180 aluminosilicate glass (0.78 mm or 2 mm) with helium or hydrogen and 3 micron titania coating. Preferred embodiments for a 10,000 hour design include all of the 2000 hour preferred embodiments, with the possible exception of He in quartz or in aluminosilicate glass requiring thicker walls. All of these solutions are expected to contain enough gas within the shroud to provide a sufficient cooling atmosphere for the arctube or light source.

With regard to He containment, it may be especially beneficial to use a high-temperature coating comprised of a magnetic compound whose lattice constant is comparable to that of He, for example NiO.

Helium is a noble gas with following physical parameters (A. F. Schuch and R. L. Mills, Phys. Rev. Lett., 1961, 6, 596.)

Structure: ccp (cubic close-packed)

Cell parameters:
a: 424.2 pm
b: 424.2 pm
c: 424.2 pm
α: 90.000°
β: 90.000°
γ: 90.000°
Ground state: 1 s²

NiO ground state is as follows with decomposition point at 1960 C which makes it good for high temperature application.

| | | | |
|---|---|---|---|
| Ni | 78.58 | 2 | [Ar].3d⁸ |
| O | 21.42 | −2 | [He].2s².2p⁶ |

Due to its inert ground state configuration, helium only induces a dipole moment with other elements or compounds. Due to the electronic configuration of NiO, the compound can induce a strong dipole moment on helium therefore trapping it better than other oxides. However, a dipole/quadropole moment can also be induced by many other similar magnetic oxides or nitride. For example, GaMnN, MnO, FeO, BiO, V₂O₃, or their alloys, or any magnetic compound with comparable lattice constant of helium as shown above which is 424.2 pico-meter. Furthermore the compounds can be nonmagnetic but behave like magnetic material by inducing a very weak dipole. For example, Sr₁₄Cu₂₄O₄₁ and La₂Cu₂O₅.

The oxide coatings can be provided typically by e-beam sputter deposition with a substrate temperature greater than 200 C to provide a defect-free film.

While hydrogen and helium, along with neon, have been the subject of most of the testing, several other cooling gases can be considered for lamp applications, particularly those gases having thermal conductivities exceeding that of nitrogen. It is expected that most or all of these relatively small molecules will benefit from longer containment times in lamp applications by incorporation of this disclosure.

In yet another embodiment, the use of an aluminosilicate glass shroud in accord with the foregoing, and in place of the conventional quartz shroud, is used in combination with the thin film oxide coating described above to further reduce and limit helium permeation. In this instance, the combination of the aluminosilicate glass shroud and a thin film oxide coating helps to maintain a desired operating pressure of the cooling gas in the shroud for optimal performance. For example, an aluminosilicate glass shroud having a thin film oxide coating thereon can contain the desired helium pressure of approximately 150 Torr.

Alternately, other modified silica coatings such as TiO₂ doped fused silica and/or boron modified quartz can also be used. The coatings may be applied through any conventional method including powder coating, fused coating, plasma spray coating, chemical vapor deposition, MO-CVD, sol gel coating, etc. Of course, a combination of the foregoing methods, including a selected area infrared reflective coating can also be used to further reduce helium loss. Low permeability coatings include, but are not limited to, soda lime glass, TiO₂, B₂O₃, P₂O₅, AlPO₄, BPO₄ modified glasses,

In those embodiments where a coating is used on the shroud, the coating may be, for example, about 1 to 5 μm of titania, tantala, alumina, or other suitable material which slows the loss of helium.

The preferred embodiments have been described. Obviously, modifications and alterations will occur to others upon reading and understanding the preceding detailed description. It is intended that this disclosure be construed as including all such modifications and alterations.

1. A method for the reduction of gas loss comprising:
providing a lamp having a high-temperature light source and a surrounding shroud; and using a fill gas with a thermal conductance greater than nitrogen between the high-temperature light source and the shroud.

2. The method of claim 1 wherein the shroud contains at least 20% of the initial fill gas for at least the rated life of lamp operation.

3. The method of claim 1 wherein the using step includes using one of helium or hydrogen or neon as the fill gas.

4. The method of claim 1 further comprising forming the shroud from aluminosilicate glass, or other high-temperature glass having a lower diffusion rate for hydrogen or helium or neon than does quartz.

5. The method of claim 1 wherein the shroud has a thickness of at least 0.5 mm.

6. The method of claim 1 wherein the shroud has a thickness of at least 1.0 mm.

7. The method of claim 1 wherein the shroud has a thickness of about 2.0 mm.

8. The method of claim 1 further comprising applying a high-temperature coating to a surface of the shroud.

9. The method of claim 1 wherein the using step includes using one of helium or hydrogen or neon as the fill gas, and further comprising forming the shroud from aluminosilicate glass or other high-temperature glass having a lower diffusion rate for hydrogen or helium or neon than does quartz.

10. The method of claim 1 wherein the using step includes using one of helium or hydrogen or neon as the fill gas, and wherein the shroud has a thickness of at least 0.5 mm thick.

11. The method of claim 1 further comprising forming the shroud from aluminosilicate glass, or other high-temperature glass having a lower diffusion rate for hydrogen or helium or neon than does quartz, and the shroud has a thickness of at least 0.5 mm thick.

12. The method of claim 1 wherein the using step includes using one of helium or hydrogen or neon as the fill gas, further comprising forming the shroud from aluminosilicate glass, or other high-temperature glass having a lower diffusion rate for hydrogen or helium or neon than does quartz, and wherein the shroud has a thickness of at least 0.5 mm thick.

13. The method of claim 1 further comprising applying a high-temperature coating to an internal surface of the shroud.

14. The method of claim 1 further comprising applying a high-temperature coating to an external surface of the shroud.

15. The method of claim 1 further comprising applying a high-temperature coating to a surface of the shroud wherein the coating includes one of alumina, silica, tantala, titania, niobia, hafnia, NiO, or other light-transmitting high-temperature material oxide, nitride or oxynitride or combinations thereof.

16. The method of claim 1 further comprising applying a high-temperature coating to a surface of the shroud wherein the coating includes a multi-layer interference coating of high and low-index materials.

17. The method of claim 1 further comprising applying a high-temperature coating to both internal and external surfaces of the shroud.

18. The method of claim 16 wherein the coating includes one of alumina, silica, tantala, titania, niobia, hafnia, NiO or other light-transmitting high-temperature material oxide, nitride or oxynitride or combinations thereof.

19. The method of claim 17 wherein the coating includes a multi-layer interference coating of high and low-index materials.

20. A high-temperature lamp comprising:
a high-temperature light source; and
a shroud surrounding the light source, and having a fill gas with a thermal conductance greater than nitrogen between the light source and the shroud, wherein the shroud contains at least 20% of an initial amount of fill gas for at least the rated life of lamp operation.

21. The lamp according to claim 20 wherein the shroud comprises quartz or aluminosilicate glass or other high-temperature glass having a lower diffusion rate for hydrogen or helium or neon than does quartz.

22. The lamp of claim 20 wherein the shroud has a thickness of approximately 1-2 mm.

23. The lamp according to claim 22 wherein the shroud comprises aluminosilicate glass or other high-temperature glass having a lower diffusion rate for hydrogen or helium or neon than does quartz.

24. The lamp of claim 23 wherein the shroud includes a high temperature coating on at least one of an interior and exterior surface of the shroud.

25. The lamp of claim 20 wherein the fill gas has a thermal conductance greater than nitrogen.

26. The lamp of claim 25 wherein the fill gas is one of helium, hydrogen, or neon.

27. The lamp of claim 20 wherein the shroud is quartz approximately 1-2 mm thick containing a fill gas of hydrogen and a titania coating on the shroud approximately 3 microns thick.

28. The lamp of claim 20 wherein the shroud is aluminosilicate glass approximately 0.78-2 mm thick containing a fill gas of hydrogen.

29. The lamp of claim 20 wherein the shroud is aluminosilicate glass approximately 0.78-2 mm thick containing a fill gas of one of hydrogen and helium and neon and a titania coating on the order of 3 microns thick.
